(19) United States
(12) Patent Application Publication
(10) Pub. No.: US 2009/0289908 A1
(43) Pub. Date: Nov. 26, 2009

(54) TOUCH DETECTING DEVICE CAPABLE OF SAVING ELECTRICITY

(76) Inventors: Po-Tsun Chen, Hsinchu County (TW); Hui-Hung Chang, Keelung City (TW); Ching-Cheng Lee, Hsinchu County (TW); Tsung-Yin Yu, Yilan County (TW)

Correspondence Address: NORTH AMERICA INTELLECTUAL PROPERTY CORPORATION, P.O. BOX 506, MERRIFIELD, VA, 22116, US

(21) Appl. No.: 12/324,842

(22) Filed: Nov. 27, 2008

(30) Foreign Application Priority Data
May 22, 2008 (TW) 097118871

(51) Int. Cl. G06F 3/041

(52) U.S. Cl. 345/173

(57) ABSTRACT

A touch detecting device capable of saving power for a touch panel includes a touch sensing unit, a micro control unit and a mode detecting unit. The touch sensing unit is coupled to the touch panel and used for being triggered by a first control signal to generate sensing data according to a touch state of the touch panel. The micro control unit is coupled to the touch sensing unit and used for being triggered by a second control signal to generate the first control signal. The mode detecting unit is coupled to the micro control unit and the touch panel, and used for generating the second control signal according to the touch state of the touch panel.

### BACKGROUND OF THE INVENTION

1. Field of the Invention

The present invention relates to a touch detecting device, and more particularly, to a touch detecting device capable of saving power.

2. Description of the Prior Art

In recent years, an electronic device with touch panel becomes a popular design orientation. The electronic device utilizes the touch panel as a communications interface with users. Thus, the users can control the electronic device by directly touching the panel with their fingers instead of using a keyboard or a mouse.

Please refer to FIG. 1, which is a functional block diagram of a touch panel system 10 according to the prior art. The touch panel system 10 includes a touch sensing unit 100, a micro control unit 110, a ring counter 120, and a host 130. Since human fingers touching a touch panel 12 can cause a change of voltage or capacitance, the touch sensing unit 100 transforms variation of the voltage or capacitance into sensing data SES_DATA, and finally the micro control unit 110 examines the SES_DATA to determine position and time information of the human finger touching. In addition, the host 130 is often used for receiving the sensing data from the micro control unit 110 to generate the information of a cursor position, and controls the micro control unit 110 through a wake-up signal SWP.

The ring counter 120 provides a constant clock for introducing a power saving mode to the touch panel system 10, which generally includes a normal mode, and two power saving modes: a period mode and a deep sleep mode. Please refer to FIG. 2, which is a schematic diagram of signal waveforms corresponding to the touch panel system 10 in the normal mode. The waveforms from top to bottom showed in sequence in FIG. 2 are: a supply voltage VCC of the touch panel system 10, a clock MCLK of the micro control unit 110, and a clock RCLK of the ring counter 120. In the normal mode, the touch sensing unit 100, the micro control unit 110, and the ring counter 120 keep activated. The micro control unit 110 detects and processes the sensing data SES_DATA according to the clock MCLK. In general, the touch panel system 10 consumes few mA (millampere) current in the normal mode.

Please refer to FIG. 3, which is a schematic diagram of signal waveforms corresponding to the touch panel system 10 in the period mode. In the period mode, the touch sensing unit 100 and the micro control unit 110 usually operate in an inactive state. The ring counter 120 utilizes the clock RCLK to set a sleep period T1, and thereby periodically awakes the micro control unit 110 to enter the normal mode. During an operation time T2 of the normal mode, the micro control unit 110 detects whether a finger touch event actually occurs according the sensing data SES_DATA, and then remains in the normal mode if the finger touch event is confirmed. However, if no finger touch event is confirmed within few seconds during the normal mode, the micro control unit 110 returns to the inactive state. Generally the touch panel system 10 consumes hundreds of μA (micro-Ampere) current in the period mode.

Please refer to FIG. 4, which is a schematic diagram of signal waveforms corresponding to the host 130 in the deep sleep mode. In the deep sleep mode, the touch sensing unit 100, the micro control unit 110, and the ring counter 120 all keep in the inactive state, and thereby cannot detect finger touches automatically. In order to detect the finger touch event, the host 130 outputs the wake up signal SWP to control the micro control unit 110 to enter the normal mode, and then the touch sensing unit 100 and the ring counter 120 enters the normal mode as well. In general, the touch panel system 10 consumes few μA current in deep sleep mode.

In order to increase power saving efficiency of the period mode, the prior art touch panel system 10 uses a longer period for the sleep period T1, or reduces the operation time T2 of the micro control unit 110. Although this way solves the problem of current consumption to a certain degree, the sensitivity of touch sensing is lowered. Also, though the touch panel system 10 in the deep sleep mode saves the most power, the host 130 needs to awake the touch panel sytem 10 periodically in this mode. Moreover, the host 130 is implemented with high-level operation processing units consuming more power, thereby causing high power consumption of the touch panel system 10. In addition, the finger touch event cannot be automatically sensed in the deep sleep mode.

### SUMMARY OF THE INVENTION

Therefore, the present invention provides a touch detecting device capable of saving power.

11 The present invention discloses a touch detecting device capable of power for a touch panel. The touch detecting device includes a touch sensing unit, a micro control unit, and a mode detecting unit. The touch sensing unit is coupled to the touch panel and used for being triggered by a first control signal to generate sensing data according to a touch state of the touch panel. The micro control unit is coupled to the touch sensing unit and used for being triggered by a second control signal to generate the first control signal. The mode detecting unit is coupled to the micro control unit and the touch panel and used for generating the second control signal according to the touch state of the touch panel.

Moreover, the present invention discloses a display device capable of saving power which includes a touch panel and a touch detecting device. The touch detecting device with a power saving mode and a normal mode includes a touch sensing unit, a micro control unit and a mode detecting unit. The touch sensing unit is coupled to the touch panel and used for being triggered by a first control signal to switch from the power saving mode to the normal mode and generate sensing data according to a touch state of touch panel. The micro control unit is coupled to the touch sensing unit and used for determining the touch state of the touch panel according to the sensing data in the normal mode, and in the power saving mode, used for being triggered by a second control signal to switch from the power saving mode into the normal mode, to generate the first control signal, and to generate a third control signal according to the sensing data. The mode detecting unit is coupled to the micro control unit and the touch panel and used for generating the second control signal according to the touch state of the touch panel in the power saving mode. The micro control unit includes a mode controller for controlling switching of the touch detecting device between the power saving mode and the normal mode according to the third control signal.

Furthermore, the present invention discloses a touch detecting device capable of saving power for a touch panel. The touch detecting device having a power saving mode and a normal mode includes a touch sensing unit, a micro control unit and a mode detecting unit. The touch sensing unit is coupled to the touch panel and used for being triggered by a first control signal to switch from the power saving mode into the normal mode, and used for generating sensing data according to a touch state of the touch panel. The micro control unit is coupled to the touch sensing unit and used for determining the touch state of the touch panel according to the sensing data in the normal mode, and in the power saving mode, for being triggered by a second control signal to switch from the power saving mode into the normal mode, to generate the first control signal, and to generate a third control signal according to the sensing data. The mode detecting unit is coupled to the micro control unit and the touch panel and used for generating the second control signal according to the touch state of the touch panel in the power saving mode. The micro control unit includes a mode controller for controlling switching of the touch detecting device between the power saving mode and the normal mode according to the third control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a touch panel system according to the prior art.

FIG. 2 is a schematic diagram of signal waveforms corresponding to the touch panel system in the normal mode.

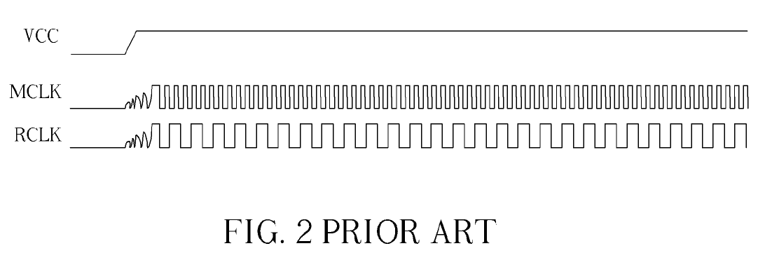

FIG. 3 is a schematic diagram of signal waveforms corresponding to the touch panel system in the period mode.

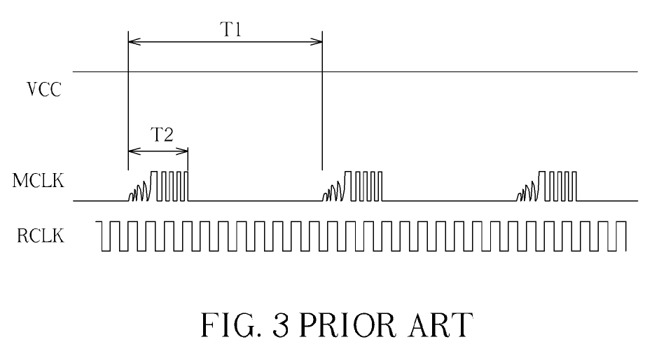

FIG. 4 is a schematic diagram of signal waveforms corresponding to the host in the deep sleep mode.

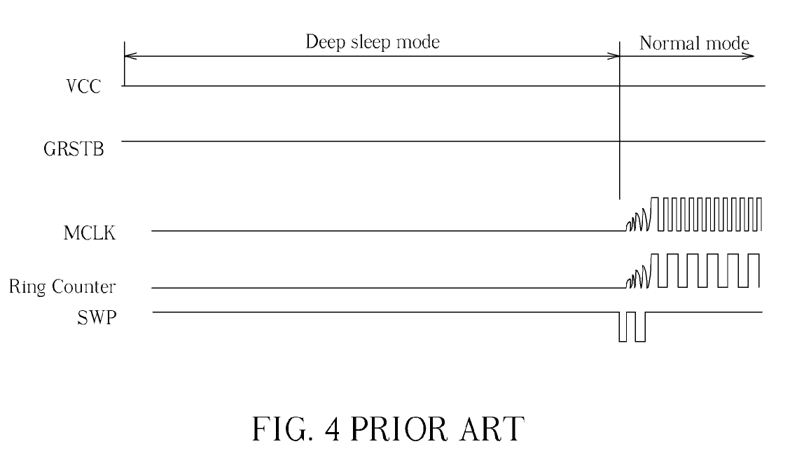

FIG. 5 is a functional block diagram of present invention applied on a display device.

FIG. 6 is an operation waveform diagram of touching detecting device in saving mode of FIG. 5.

### DETAILED DESCRIPTION

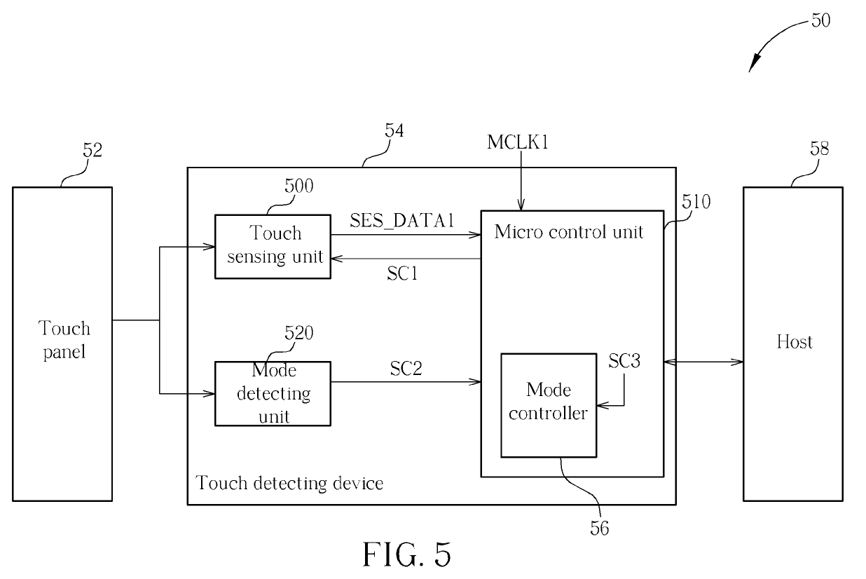

Please refer to FIG. 5, which is a functional block diagram of a display device 50 according to an embodiment of the present invention. The display device 50 includes a touch panel 52, a touch detecting device 54, a mode controller 56, and a host 58. The touch detecting device 54 senses a finger touch event on the touch panel 52 in a power saving mode or a normal mode and includes a touch sensing unit 500, a micro control unit 510, and a mode detecting unit 520.

In the normal mode, the touch sensing unit 500 generates sensing data SES_DATA1 according to a touch state of the touch panel 52. The micro control unit 510 determines the touch state of the touch panel 52 according to the sensing data SES_DATA1. The mode detecting unit 520 stays inactive during the normal mode.

In the power saving mode, the mode detecting unit 520 generates a second control signal SC2 according to a touch state of the touch panel 52. The second control signal SC2 triggers the micro control unit 510 to generate a first control signal SC1 and enter the normal mode. The touch sensing unit 500 is triggered by the first control signal SC1 to switch from the power saving mode to the normal mode, and thereby generates sensing data SES_DATA1 according to the touch state of touch panel 52. The micro control unit 510 determines whether a finger touch event occurs on the touch panel 52 according the sensing data SES_DATA1, and generates a corresponding third control signal SC3.

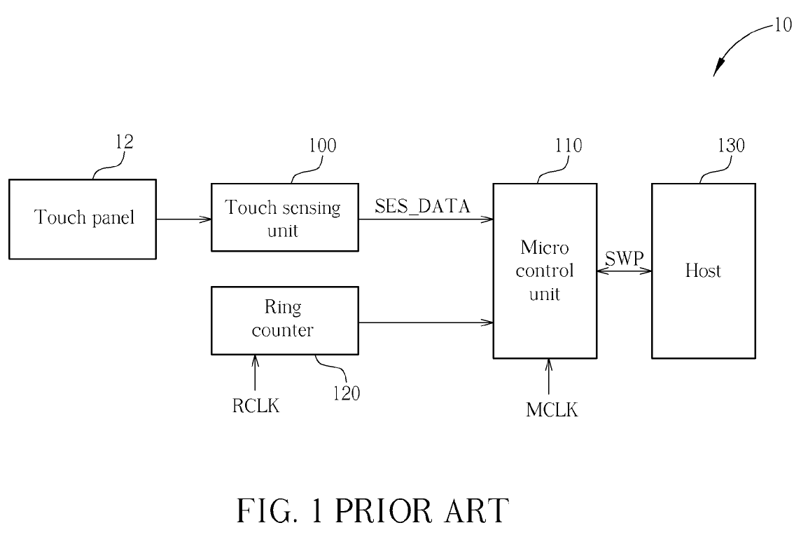

The mode controller 56 controls the switching of the power saving mode and the normal mode of the touch detecting device 54 according to the third control signal SC3. If the third control signal SC3 indicates occurrence of the finger touch event, the mode controller 56 controls the touch detecting device 54 to enter the normal mode. If the third control signal SC3 indicates no finger touch event, this may be caused by noise or trivial touches on the touch panel 52, and thus the mode controller 56 controls the touch detecting device 54 to enter the power saving mode again. The host 58 is coupled to the micro control unit 510, and the operation principle thereof is identical with that of the host 130 shown in FIG. 1. Therefore, the detailed description of the host 58 is omitted herein.

As can be seen from the above, the embodiment of the present invention utilizes the mode detecting unit 520 to perform a coarse touch detection and awakes the micro control unit 510 according to the detecting result (through the second control signal SC2), such that the micro control unit 510 and the touch sensing unit 500 are awaken to enter the “temporary” normal mode. Thus, the micro control unit 510 can determine whether a finger touch event really occurs according the received sensing data SES_DATA1, and thereby determine whether to operate the touch detecting device 54 in a “real” normal mode through controlling of the mode controller 56.

The technique of the mode detecting unit 520 shall be fairly known for people having ordinary skill in the art. For example, the mode detecting unit 520 can be implemented by fundamental circuit components to perform the coarse detection of the touch state. Thus the second control signal SC2 contains less touch information so that the micro control unit 510 cannot entirely rely on the second control signal SC2 about the determining results of the finger touch event. Therefore, the micro control unit 510 still needs the sensing data SES_DATA1 which includes adequate touch information.

In addition, the circuit of the mode detecting unit 520 is fairly basic compared with the touch sensing unit 500. Because the circuit complexity and the power consumption of the mode detecting unit 520 are both lower, the coarse touch detection consumes less power, and because the mode detecting unit 520 keeps awake for detecting the touch state, the sensibility of touch detecting device 54 is, as a whole, more advanced than the prior art.

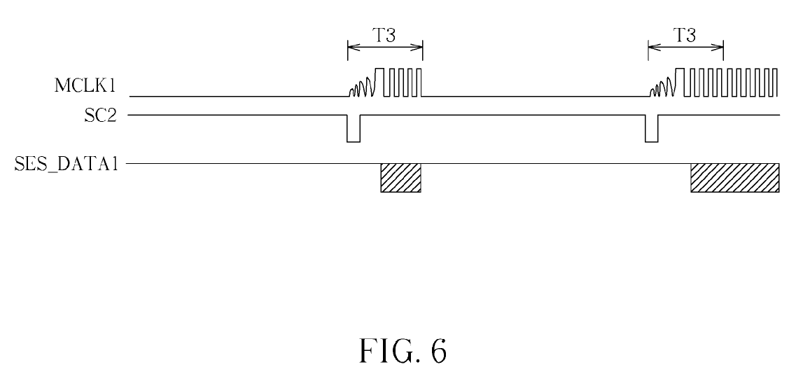

Please refer to the FIG. 6, which is an operation waveform diagram of the touching detecting device 54 in the power saving mode. The waveforms from top to bottom shown in sequence in FIG. 6 are: a clock MCLK1 of the micro control unit 510, the second control signal SC2, and the sensing data SES_DATA1. Generally, the micro control unit 510 and the touch sensing unit 500 are operated in an inactive state. If a transition appears in the second control signal SC2, this means that the mode detecting unit 520 detects a finger touch event on the touch panel 52, and thereby the micro control unit 510 and the touch sensing unit 500 enter the normal mode. In an operation period T3 of the normal mode, the micro control unit 510 determines whether a finger touch event occurs according to the sensing data SES_DATA1, and then controls the touch detecting device 54 to keep operation in the normal mode or return to the inactive state.

Preferably, the touch panel 52 is a capacitive touch panel, and the mode detecting unit 520 includes a resistor-capacitor circuit. Capacitive effect is incurred when a human finger touches the touch panel 52. The operative capacitance of the mode detecting unit 520 accordingly changes, thereby causing changes of a charge or discharge waveform of the resistor-capacitor circuit. Thus, the mode detecting unit 520 can detect the finger touch event to generate the second control signal SC2 through the change of the charge and discharge waveform. Generally, the detecting operation of the mode detecting unit 520 just consumes few μA (micro-Ampere) current, and the power consumption is approximately equivalent to the power consumption of the deep sleep mode of the touch panel system 10 of the prior art.

Therefore, when the touch detecting device 54 operates in the power saving mode, the mode detecting unit 520 not only can detect the finger touch event automatically to keep the sensitivity of the touch sensing, but also achieve a goal of saving power.

In conclusion, the touch panel system of the prior art can maintain the sensitivity of sensing through the periodically awaking of the power saving mode, but the drawback is it consumes more power. The touch panel system of the prior art also can lower the power consumption through the periodical deep sleep mode, but it reduces the sensitivity of touch sensing. On the other hand, the embodiment of the present invention provides a mode detecting unit in the power saving mode to detect the finger touch event automatically to achieve the goal of high sensing sensitivity and low power consumption.

Those skilled in the art will readily observe that numerous modifications and alterations of the device and method may be made while retaining the teachings of the invention.

What is claimed is:

1. A touch detecting device capable of saving power for a touch panel, the touch detecting device comprising:
a touch sensing unit coupled to the touch panel, for being triggered by a first control signal to generate sensing data according to a touch state of the touch panel;
a micro control unit coupled to the touch sensing unit, for being triggered by a second control signal to generate the first control signal; and
a mode detecting unit coupled to the micro control unit and the touch panel, for generating the second control signal according to the touch state of the touch panel.

2. The touch detecting device of claim 1, wherein the touch panel is a capacitive touch panel.

3. The touch detecting device of claim 2, wherein the mode detecting unit comprises a resistor-capacitor (RC) circuit.

4. The touch detecting device of claim 3, wherein the touch state of the touch panel changes a circuit waveform of the RC circuit.

5. The touch detecting device of claim 1, wherein the micro control unit determines the touch state of the touch panel according to the sensing data.

6. A display device capable of saving power comprising:
a touch panel; and
a touch detecting device having a power saving mode and a normal mode, the touch detecting device comprising:
a touch sensing unit coupled to the touch panel, for being triggered by a first control signal to switch from the power saving mode to the normal mode and generate sensing data according to a touch state of the touch panel in the normal mode;
a micro control unit coupled to the touch sensing unit, for determining the touch state of the touch panel according to the sensing data in the normal mode, and in the power saving mode, for being triggered by a second control signal to switch from the power saving mode into the normal mode, to generate the first control signal, and to generate a third control signal according to the sensing data, the micro control unit comprising a mode controller for controlling switching of the touch detecting device between the power saving mode and the normal mode according to the third control signal; and
a mode detecting unit coupled to the micro control unit and the touch panel, for generating the second control signal according to the touch state of the touch panel in the power saving mode.

7. The display device of claim 6, wherein the touch panel is a capacitive touch panel.

8. The display device of claim 7, wherein the mode detecting unit comprises a resistor-capacitor (RC) circuit.

9. The display device of claim 8, wherein the touch state of the touch panel changes a circuit waveform of the RC circuit.

10. A touch detecting device capable of saving power for a touch panel, the touch detecting device having a power saving mode and a normal mode, the touch detecting device comprising:
a touch sensing unit coupled to the touch panel, for being triggered by a first control signal to switch from the power saving mode to the normal mode, and for generating sensing data according to a touch state of the touch panel in the normal mode;
a micro control unit coupled to the touch sensing unit, for determining the touch state of the touch panel according to the sensing data in the normal mode, and in the power saving mode, for being triggered by a second control signal to switch from the power saving mode into the normal mode, to generate the first control signal, and to generate a third control signal according to the sensing data, the micro control unit comprising a mode controller for controlling switching of the touch detecting device between the power saving mode and the normal mode according to the third control signal; and
a mode detecting unit coupled to the micro control unit and the touch panel, for generating the second control signal according to the touch state of the touch panel in the power saving mode.

11. The touch detecting device of claim 10, wherein the touch panel is a capacitive touch panel.

12. The touch detecting device of claim 11, wherein the mode detecting unit comprises a resistor-capacitor (RC) circuit.

13. The touch detecting device of claim 12, wherein the touch state of the touch panel changes a circuit waveform of the RC circuit.
